(19) United States
(12) Patent Application Publication
(10) Pub. No.: US 2025/0289645 A1
(43) Pub. Date: Sep. 18, 2025

(54) Insulated Container

(71) Applicant: Airlite Plastics Co., Omaha, NE (US)

(72) Inventors: Robert William Menzel, JR., Mooresville, NC (US); David Kevin Vance, Concord, NC (US)

(21) Appl. No.: 19/223,522

(22) Filed: May 30, 2025

Related U.S. Application Data
(63) Continuation of application No. 18/667,637, filed on May 17, 2024.
Application No. 18/667,637 is a continuation of application No. 15/977,520, filed on May 11, 2018, now abandoned.
Application No. 15/977,520 is a continuation of application No. PCT/US18/32101, filed on May 10, 2018.
Application No. 15/977,520 is a continuation-in-part of application No. 15/959,801, filed on Apr. 23, 2018, now Pat. No. 10,246,236.
Application No. 15/959,801 is a division of application No. 15/436,417, filed on Feb. 17, 2017, now Pat. No. 10,112,756.
Application No. 15/977,520 is a continuation-in-part of application No. 35/001,475, filed on Dec. 22, 2017, now Pat. No. D864721.
Application No. 35/001,475 is a continuation-in-part of application No. PCT/US17/18461, filed on Feb. 17, 2017.
(60) Provisional application No. 62/338,136, filed on May 18, 2016.
(60) Provisional application No. 62/338,136, filed on May 18, 2016.
(60) Provisional application No. 62/609,102, filed on Dec. 21, 2017.

(51) Int. Cl. B65D 81/38; B32B 37/18; B65D 65/46

(52) U.S. Cl. CPC B65D 81/3858; B32B 37/18; B65D 65/466; B65D 81/3862; B32B 2439/62; B32B 2439/80; Y02W 90/10

(57) ABSTRACT

An insulated container may include a rigid container surrounding an insulation layer formed from a post-industrial, pre-consumer card waste. The insulation layer may include a natural fiber lamination layer on an outer surface of the insulation layer or may be housed in a biodegradable plastic. The insulated layer may be manufactured in a capital “T” shape such that it may be folded for compact transportation prior to end use. The folded insulation layer may bound by a separable band. The separable band may be removed when folded insulation layer is placed in the rigid container. The insulation layer and the band may be biodegradable in an anaerobic environment.

### CROSS-REFERENCE TO RELATED APPLICATIONS

This application is a continuation of U.S. patent application Ser. No. 18/667,637, filed May 17, 2024, which is a continuation of U.S. patent application Ser. No. 15/977,520, filed May 11, 2018, now abandoned, which is a continuation of International Patent Application No. PCT/US2018/032101, filed May 10, 2018, which is a nonprovisional of and claims priority to U.S. Provisional Application No. 62/609,102, filed Dec. 21, 2017; and U.S. patent application Ser. No. 15/977,520 is also a continuation-in-part of U.S. patent application Ser. No. 15/959,801, filed Apr. 23, 2018, and issued as U.S. Pat. No. 10,246,236 on Apr. 2, 2019, which is a divisional of U.S. patent application Ser. No. 15/436,417, filed Feb. 17, 2017, and issued as U.S. Pat. No. 10,112,756 on Oct. 30, 2018, which is a nonprovisional of and claims priority to U.S. Provisional Application No. 62/338,136, filed May 18, 2016; and U.S. patent application Ser. No. 15/977,520 is also a continuation-in-part of International Application No. PCT/US2017/018461, filed Feb. 17, 2017, which is a nonprovisional of and claims priority to U.S. Provisional Application No. 62/338,136, filed May 18, 2016; and U.S. patent application Ser. No. 15/977,520 is also a continuation-in-part of U.S. Design patent application Ser. No. 35/001,475, filed as International Design Registration DM/0099523 on Dec. 22, 2017, and issued as U.S. Design Pat. No. D864,721 on Oct. 29, 2019; and the present application claims priority to and the benefit of all of such prior applications, which are all incorporated by reference herein in their entireties.

### TECHNICAL FIELD AND BACKGROUND OF THE INVENTION

The present invention relates to the field of containers and to the field of insulated containers. More particularly, the present invention relates to the field of insulated shipping containers utilizing sustainable materials including recycled post-industrial, pre-consumer natural fiber. The containers according to the present invention may be used in transporting and storing objects which may be at a temperature that is different from the temperature outside the container.

Temperature sensitive products need to be transported from time to time. For instance, certain medications may need to be kept cool relative to temperatures outside of the container. In other instances, food may need to be kept warm relative to temperatures outside of the container. As a result of these needs, packaging has been designed to maintain an internal temperature according the requirements of the product. Some packaging may utilize electro-mechanical devices such as refrigeration, heat exchangers, or heat sinks in order to provide a required steady temperature. Other packaging may utilize foams, plastics, and other polymers along with cool packs, water ice, or dry ice in order to maintain the required temperature environment inside the packaging.

However, many of these packages and devices are expensive and heavy (as with the refrigeration and heat sinks) or are harmful to the environment (as with some refrigeration and also the foams and plastics) or both. Because of these problems, some have devised products which may be made from post-consumer waste such as recycled cotton gathered from used clothing. However, these products may be prone to contamination from yarn dies, applied chemicals, and other contaminants which the clothing may have acquired during the period of use. The post-consumer material must be cleaned and shredded ahead of reprocessing, however, this process does not eliminate yarn dies and the possibility of contaminants. Most post-consumer waste retains a blue colorization after processing. Therefore, because of the contamination and residual colorization issues these products require that any insulation manufactured from post-consumer cotton be wrapped in another material such as plastic. This use of plastic and other barriers undermines the environmental incentive for using a recycled product by posing additional environmental concerns. It may also further add to the manufacturing costs.

Accordingly, there is a long felt need in the art for a packaging material which affords safe transportation of temperature sensitive materials, which has a consistent density, which maintains an in internal temperature relative an external temperature, which is efficiently and economically manufactured, which is lightweight, and which minimizes negative impacts to the environment.

Another problem in the art is that insulated containers are often manufactured by a different company than a packager who sends products. Or, the insulated containers may be made in a different facility which may be some geographic distance away from where the packager may ultimately place products in the package for shipment to a consumer.

Accordingly, there is a long felt need in the art for a package may be efficiently transported from a manufacturing facility to a packaging facility for shipment to an end user.

### BRIEF SUMMARY OF THE INVENTION

The present invention is an insulated shipping container which affords safe transportation of temperature sensitive products, which has a consistent density, which maintains an in internal temperature relative to an external temperature, which is efficiently and economically manufactured, which is lightweight, and which minimizes negative impacts to the environment.

The present invention may utilize post-industrial, pre-consumer cotton waste. Post-industrial, pre-consumer cotton waste may include fiber material gleaned and/or trimmed as part of cotton manufacturing, and converting process.

Such fiber material, collected from the manufacturing process, may contain small pieces of cotton seed pods and stems removed as part of the manufacturing process. These fiber materials have not been converted into finished products (such as clothing or other fabrics). Thus, the present invention is directed to an insulated shipping container utilizing unwrapped cotton waste as the thermal insulating layer.

However, the invention is not limited only to waste generated from a single manufacturing or converting process. As such, post-industrial, pre-consumer waste may be from raw cotton processing, cotton yarn manufacturing, cotton fabric manufacturing and related processes such as carding, airlay, garneting, and other similar methods of manufacturing.

According to one aspect of the invention, the use of polyethylene film wrapped around pads manufactured from cotton waste can be eliminated. No wrapping is required by the present invention and exposed fibers alone can be utilized. Because the fibers are pre-consumer, according to the present invention, the risk of cross contamination from post-consumer recycled products is eliminated.

Alternatively, a natural fiber lamination may be applied to surfaces in order to provide a smoother surface wherein images and indicia may be applied. The elimination of poly wrap may provide an environmental benefit and also be a cost saving measure. The entirety of the insulation layer, whether including fibers alone or also including the laminated layer is biodegradable in anaerobic environments.

According to one embodiment of the invention, the insulating layer may have applied to it one or more natural fiber lamination layers. The natural fiber lamination layer may be applied to an outer surface of the insulating layer which may be a contact surface. In some embodiments, the natural fiber lamination layer may be applied to only one surface or may be applied to two surfaces but need not be applied to side edge surfaces.

According to one embodiment of the invention, an insulated container may include a rigid container surrounding an insulation layer formed from a post-industrial cotton waste. The insulation layer may be characterized by a lack of any wrapping material.

According to another embodiment of the invention, the rigid container may be made from cardboard.

According to another embodiment of the invention, the rigid container may be made from plastic. The plastic may be a reusable plastic.

According to another embodiment of the invention, the insulation layer may include a pair of interlocking C-shaped members forming an enclosed cube shaped cavity. The interior of the cube may form an interior portion of the insulated container.

According to another embodiment of the invention, the interlocking C-shaped members, referred to as an “A” and a “B” pad, may have a top portion which is integrally and hingedly formed in the member for providing access to an interior portion of the insulated container.

According to a method of practicing the invention, an insulated container may be manufactured by providing a rigid container and providing a quantity of post-industrial cotton waste. This post-industrial cotton waste may then be processed into a fiber sheet. The sheet made from the waste may be formed using a variety of converting processes including, carding, airlay, and needle punch to achieve a specified thickness and density. Next, the sheet may be cut into rectangular sections. A pair of sections may be arranged to form interlocking C-shaped members. The pair of sections, referred to as an “A” pad and a “B” pad, may then be placed into the rigid container.

According to another aspect of the method, the method may further include the step of laminating a natural fiber lamination layer to the fiber sheet.

According to another aspect of the method, the cotton waste includes cotton waste generated from one or more of cotton processing, cotton manufacturing, and/or cotton converting.

According to another aspect of the method, the insulation layer is capable of maintaining a constant internal temperature for 48 hours where three 500 ML and two 250 ML IV bags are cooled by four 24 oz frozen ice packs placed at the top and bottom below a payload.

According to another aspect of the method, the insulation layer is biodegradable in an anaerobic environment.

According to another aspect of the invention, both the rigid container and the pair of sections of the insulation layer may be provided to an end user in sheet form and may be assembled into the insulated container by the end user.

According to another embodiment of the invention, the insulated container may include an insulation layer formed from a post-industrial, pre-consumer cotton waste, a rigid cardboard container surrounding the insulation layer, and a natural fiber lamination layer applied to a contact surface of the insulation layer. According to such an embodiment, the cotton waste may include cotton waste generated from one or more of cotton processing, cotton manufacturing, and/or cotton converting. According to such an embodiment, the insulation layer may be biodegradable in an anaerobic environment. According to such an embodiment, the insulation layer may be capable of maintaining a constant internal temperature for 48 hours where three 500 ML and two 250 ML IV bags are cooled by four 24 oz frozen ice packs placed at the top and bottom below a payload.

According to one embodiment, the term biodegradable may mean that the insulation layer will biodegrade completely within one year or less when subjected to the biodegration dynamics contained in ASTM D5511. According to the ASTM D5511 protocol, test reaction mixture consisted of 10% shredded nitrile gloves, 10% Trypticase Soy Broth. 10% Thioglycollate medium, 60% municipal solid waste, and inoculated with concentrated inoculum (1.2×106 CFU/ml) of aerobic and anaerobic mixed culture in 0.01 M phosphate buffer at pH 7.2 placed in aerobic and anaerobic glass digesters, and incubated at 37.5°, Positive controls consisted of reaction mixture above with lab-grade cellulose (100%, Aldrich) instead of shredded test sample(s) while negative controls contained EDTA lab-grade (100%, Aldrich) instead of shredded test sample(s) in the test above. Reaction mixture was monitored at least daily, often more frequently, and sampled weekly for CO2 production, trapped in 3 KOH bottles connected in series, over a period of 15 weeks when cumulative CO2 production was observed. Biodegradation was deemed to be positive (passed P test, 95 or >95% biodegradation) or negative (failed test, 5 or <5% biodegradation), based on carbon conversion. Percentages (%), actual observed versus theoretical possible—based on total carbon content—were determined on a dry weight basis.

According to another embodiment of the invention, an insulation layer for an insulated container may include an insulation layer, operating from an unfolded position, to a folded position, to a partially folded operating position and having a capital “T” shape in the unfolded position. A band may be wrapped around the insulation layer in the folded position. The insulation layer may be formed from a post-industrial, pre-consumer cotton waste.

According to another embodiment of the invention, the insulation layer is characterized by a lack of any wrapping material and an outer contact surface is the post-industrial, pre-consumer cotton waste.

According to another embodiment of the invention, the insulation further may include a natural fiber lamination layer attached to contact surface of the post-industrial, pre-consumer cotton waste.

According to another embodiment of the invention, the insulation layer may further include a biodegradable plastic wrapping which envelops the insulation layer.

According to another embodiment of the invention, the band may completely encircle the insulation pad in the folded position.

According to another embodiment of the invention, the band may have a width which is less than 20 percent of a width of the insulation layer in the folded position.

According to another embodiment of the invention, the band may be made from a biodegradable material.

According to another embodiment of the invention, the band may be made from paper.

According to another embodiment of the invention, the band may further comprise a first end and a second end which are attached when the band is wrapped around the insulation layer in the folded position.

According to another embodiment of the invention, the insulation layer is capable of maintaining a constant internal temperature for 48 hours where three 500 ML and two 250 ML IV bags are cooled by four 24 oz frozen ice packs placed at the top and bottom below a payload.

According to another embodiment of the invention, a method of preparing an insulated container may include the steps of providing an insulation layer formed in a capital “T” shape in an unfolded, flat position: folding the insulation layer into a folded, compact position; and wrapping and securing a band around the insulation layer in the folded position.

According to another embodiment of the invention, the method may further include the steps of providing a rigid container; placing the insulation layer, in the folded position, into the rigid container; separating the band: partially unfolding the insulation layer to form a void in the center of the insulation layer and; placing a product in the void.

According to another embodiment of the invention, a method of preparing an insulated container comprising the steps of: providing an insulation layer formed in a pair of rectangular pads in an unfolded, flat position: folding the insulation layer into a folded, compact position; and wrapping and securing a band around the insulation layer in the folded position.

According to another embodiment of the invention, the method may further include the steps of: providing a rigid container; placing the insulation layer, in the folded position, into the rigid container; separating the band; partially unfolding the insulation layer to form a void in the center of the insulation layer; and placing a product in the void.

### BRIEF DESCRIPTION OF THE DRAWINGS

Features, aspects and advantages of the present invention are understood when the following detailed description of the invention is read with reference to the accompanying drawings, in which:

FIG. 1 is an exploded view of the insulated container in a partially assembled state;

FIG. 2 is an exploded view of the insulated container in a partially assembled state;

FIG. 3 is an exploded view of the insulated container in an unassembled state;

FIG. 4 is an exploded view of the insulated container in a partially assembled state;

FIG. 5 is an exploded view of the insulated container in a partially assembled state;

FIG. 6 is an exploded view of the insulated container in a partially assembled state;

FIG. 7 is an exploded view of the insulated container in a partially assembled state;

FIG. 8 is an exploded view of the insulated container in a partially assembled state;

FIG. 9 is a perspective view of the insulated container in an assembled state;

FIG. 10 is a perspective view of the insulated container in an assembled state;

FIG. 10A is sectional view of the insulated container;

FIG. 11 is an exploded view of the insulated container in a partially assembled state and where the insulation layer does not include the natural fiber lamination;

FIG. 12 is a heat stress chart;

FIG. 13 is a heat stress chart;

FIG. 14 is a cold stress chart;

FIG. 15A is a perspective view of an embodiment of the insulated container in an unfolded position:

FIG. 15B is a perspective view of an embodiment of the insulated container in the unfolded position;

FIG. 15C is a perspective view of an embodiment of the insulated container in the unfolded position;

FIG. 16 is a perspective view of the embodiment of the insulated container of FIGS. 15A-C in a process of folding from the unfolded position to a folded position;

FIG. 17 is a perspective view of the embodiment of the insulated container of FIGS. 15A-C in the process of folding from the unfolded position to the folded position;

FIG. 18 is a perspective view of the embodiment of the insulated container of FIGS. 15A-C in the process of folding from the unfolded position to the folded position;

FIG. 19 is a perspective view of the embodiment of the insulated container of FIGS. 15A-C in the process of folding from the unfolded position to the folded position;

FIG. 20 is a perspective view of the embodiment of the insulated container of FIGS. 15A-C in the folded orientation;

FIG. 21 is a perspective view of the embodiment of the insulated container of FIGS. 15A-C in the folded orientation;

FIG. 22 is a perspective view of the embodiment of the insulated container of FIGS. 15A-C in the folded orientation;

FIG. 23 is a perspective view of the embodiment of the insulated container of FIGS. 15A-C in the folded orientation;

FIG. 24 is a perspective view of the embodiment of the insulated container of FIGS. 15A-C in the folded orientation and being placed in a rigid container;

FIG. 25 is a perspective view of the embodiment of the insulated container of FIGS. 15A-C in the folded orientation and placed in the rigid container:

FIG. 26 is a perspective view of the embodiment of the insulated container of FIGS. 15A-C in the folded orientation, placed in the rigid container, and being opened;

FIG. 27 is a perspective view of the embodiment of the insulated container of FIGS. 15A-C in a partially-unfolded position within the rigid container;

FIG. 28 is a perspective view of the embodiment of the insulated container of FIGS. 15A-C in the partially-unfolded position within the rigid container and having contents placed therein;

FIG. 29A is a perspective view of an embodiment of the insulated container in an unfolded orientation;

FIG. 29B is a perspective view of an embodiment of the insulated container in an unfolded orientation:

FIG. 29C is a perspective view of an embodiment of the insulated container in an unfolded orientation;

FIG. 30 is a perspective view of an embodiment of the insulated container in a partially folded orientation;

FIG. 31 is a perspective view of an embodiment of the insulated container in a partially folded orientation;

FIG. 32 is a perspective view of an embodiment of the insulated container in a folded orientation;

FIG. 33 is a perspective view of an embodiment of the insulated container in a folded orientation;

FIG. 34 is a perspective view of an embodiment of the insulated container in a folded orientation:

FIG. 35 is a perspective view of an embodiment of the insulated container in a partially folded orientation and being placed in a rigid container;

FIG. 36 is a perspective view of an embodiment of the insulated container in a folded orientation and placed in a rigid container:

FIG. 37 is a perspective view of an embodiment of the insulated container in a folded orientation, placed in a rigid container, and being opened;

FIG. 38 is a perspective view of an embodiment of the insulated container in an open position within the rigid container; and

FIG. 39 is a perspective view of an embodiment of the insulated container in an open position within the rigid container and having contents placed therein.

### DETAILED DESCRIPTION OF THE INVENTION

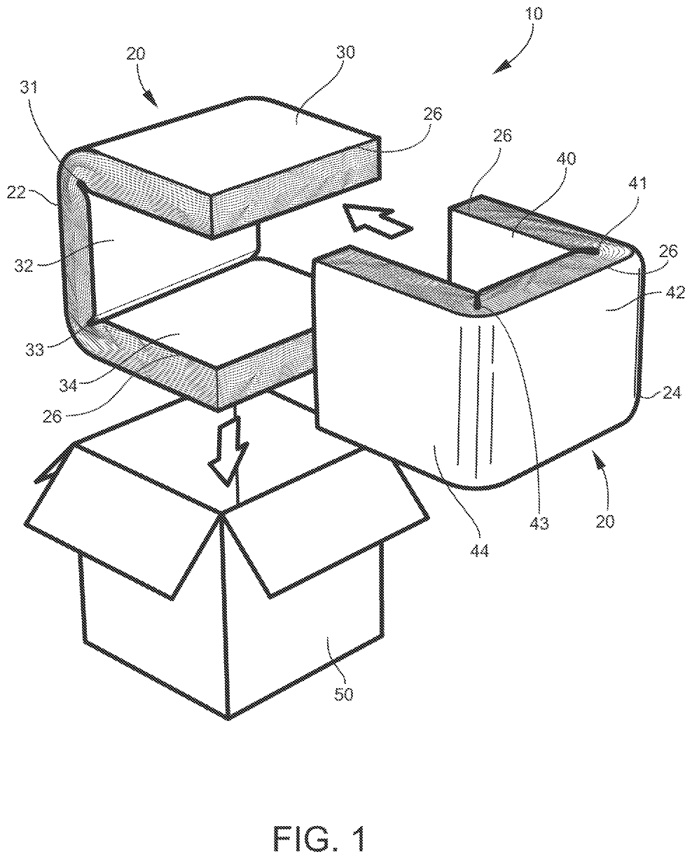

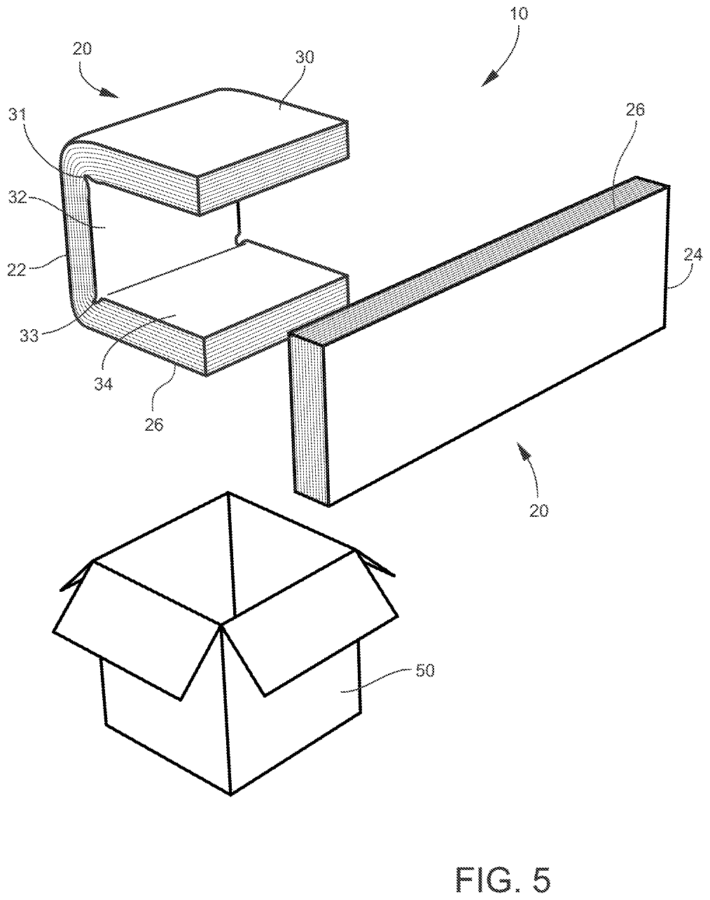

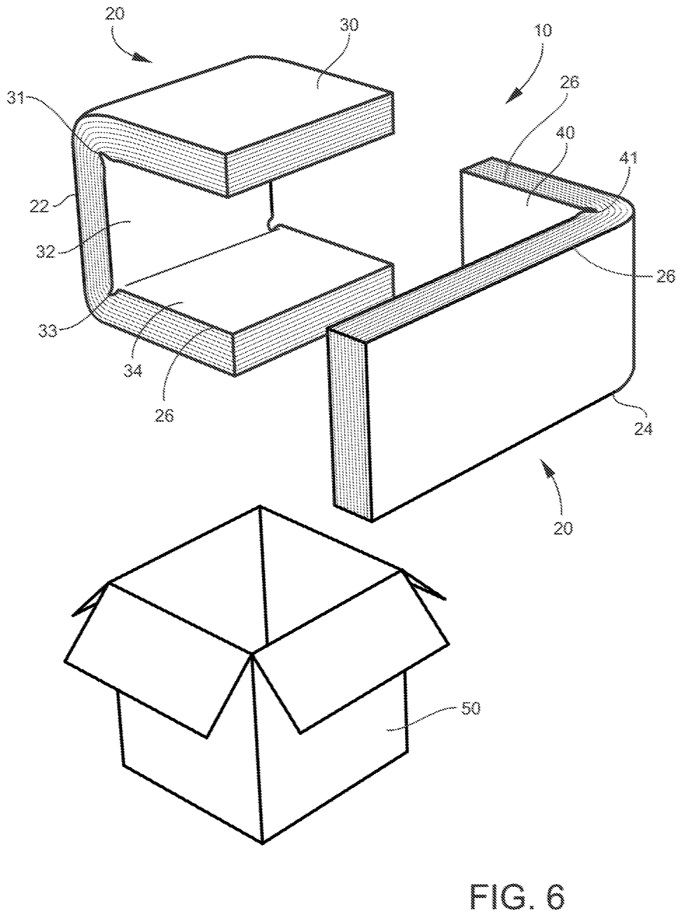

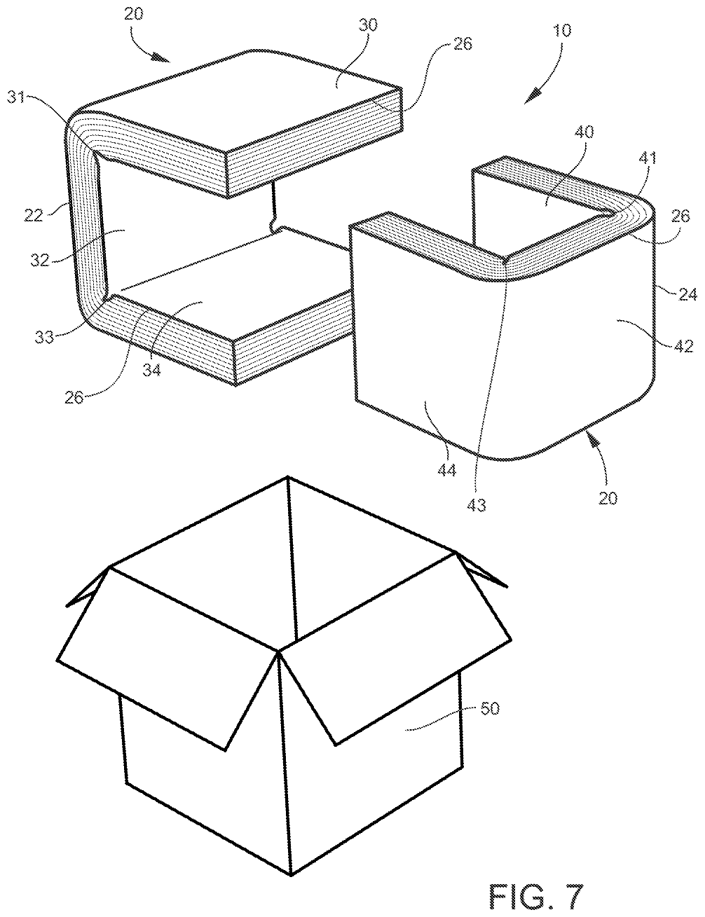

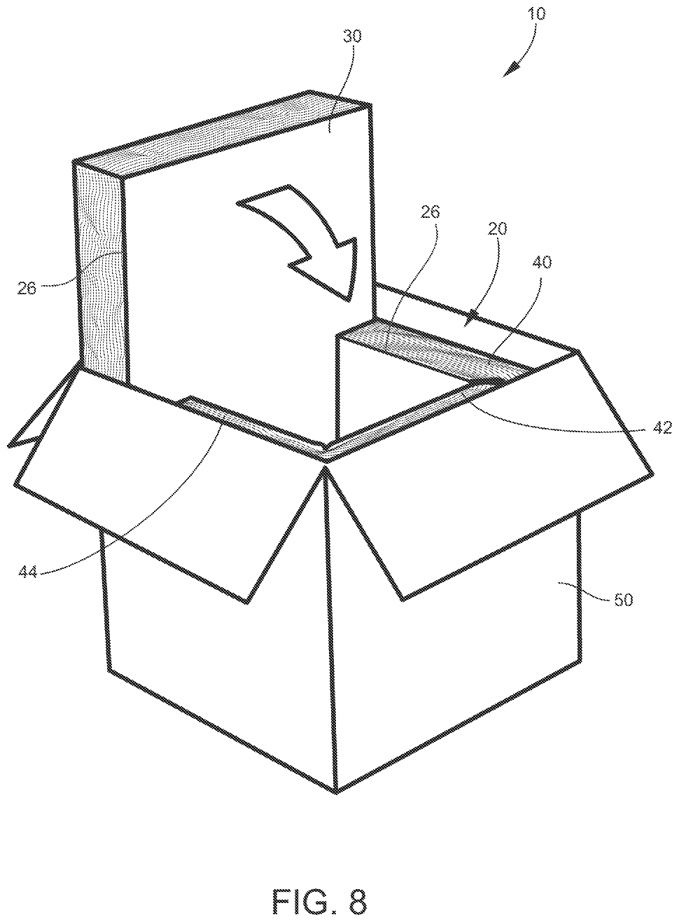

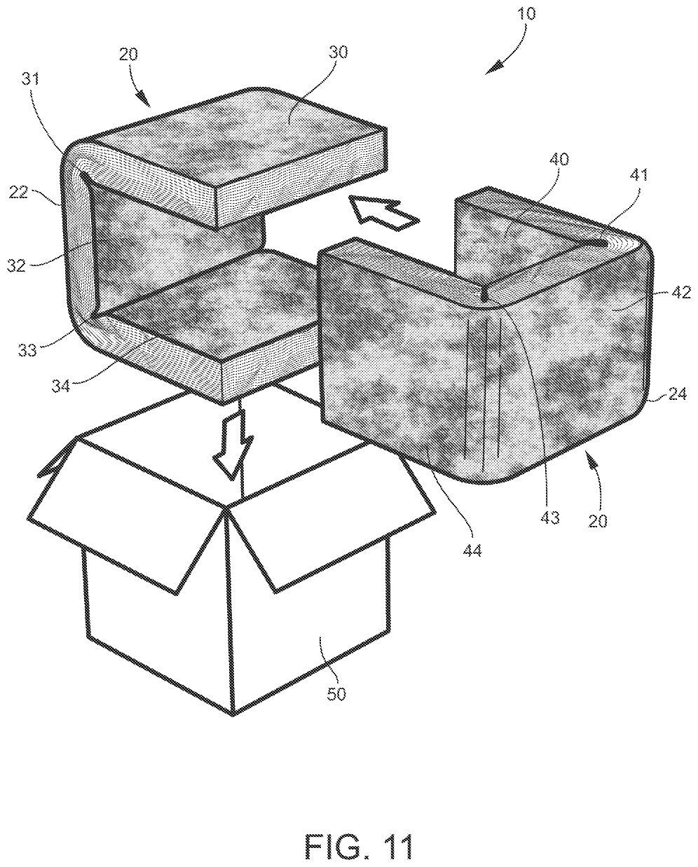

Generally, FIGS. 1 through 8, show embodiments of the invention with insulation layer 20 having a natural fiber lamination layer 26 applied to contact surfaces. The contact surfaces are surfaces which may come into contact with contents of the container. Generally, FIG. 11 shows an alternate embodiment of the invention where there is no natural fiber lamination layer and the fibers of the insulation layer 20 are exposed to the contents of the container. The embodiment utilizing the natural lamination layer 26 may be preferred to the embodiment of FIG. 11 when a shipper desires that the contents not come into contact with the insulation layer, such as when shipping raw, unwrapped produce. The natural fiber lamination layer 26 is sustainable and is biodegradable. The natural fiber lamination layer 26 thus provides a helpful option to companies seeking a smoother, more consistent surface. The natural fiber lamination layer 26 may be made from a coffee filter paper, kraft paper, and the like. Text and images (not shown) may be printed on the lamination layer 26.

Referring to FIG. 1, an insulated container 10 is shown in a partially assembled state. The insulated container 10 includes rigid container 50 and insulation layer 20. The rigid container 50 may be a cardboard box as shown. The insulation layer 20 is made from cotton waste. The cotton waste is processed into a sheet formed using a variety of converting processes including, carding, airlay, and needle punch to form a non-woven sheet. The insulation layer 20 is formed to maintain uniform density and of a thickness optimized for particular applications.

The sheet may then be cut into rectangles which may be bent into a pair of C-shaped members, 22, 24. The first C-shaped member, referred to as an “A” pad 22 forms lid portion 30 which is connected to back side portion 32 via first hinge portion 31. Bottom portion 34 is connected to back portion 32 via second hinge portion 33.

Similarly, the second C-shaped member, referred to as a “B” pad 24 forms first side portion 40 which is connected to front side portion 24 via hinge 41. Second side portion 44 is connected to front side portion 24 via hinge portion 43.

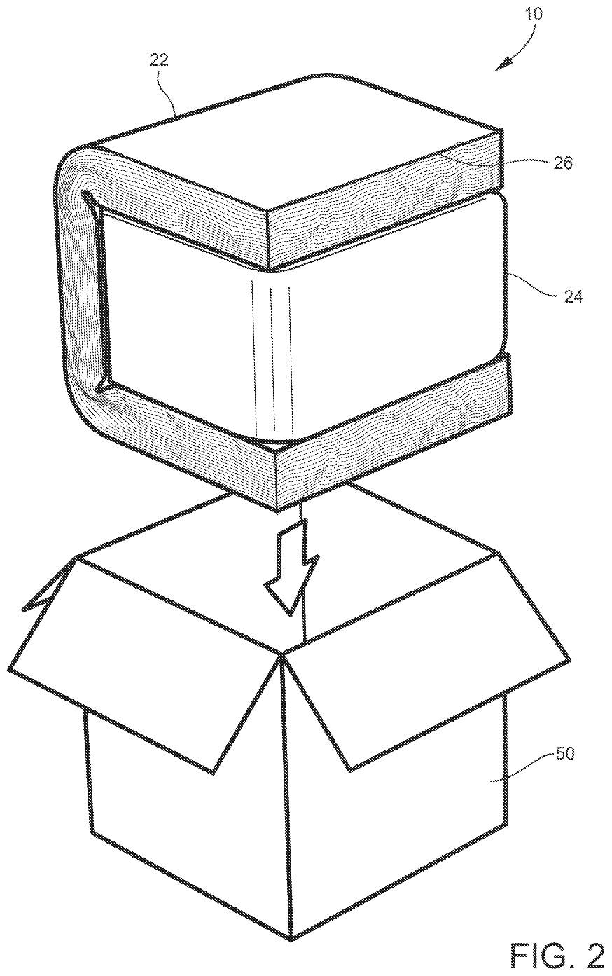

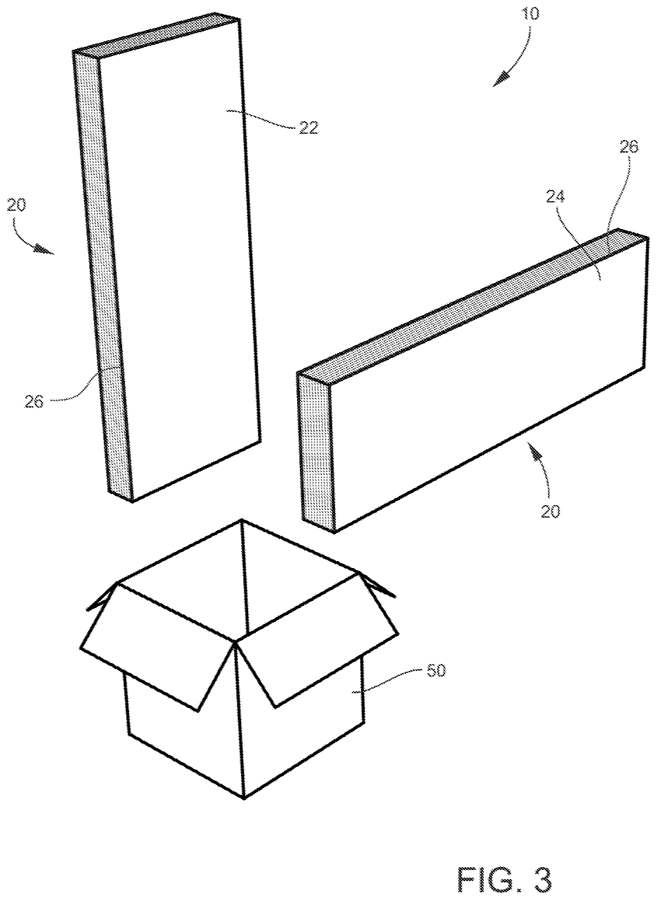

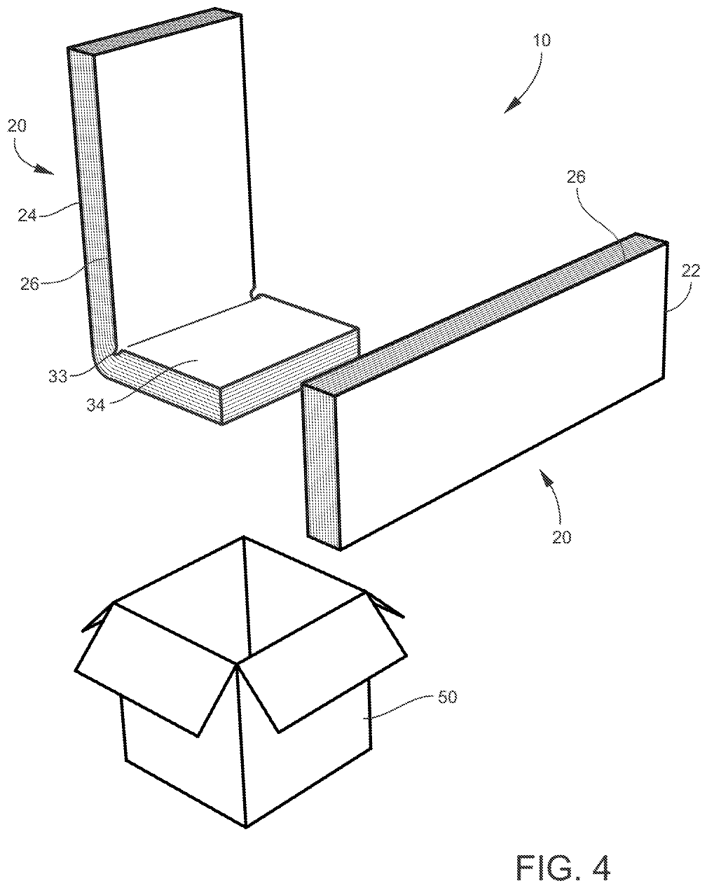

When assembled, as shown in FIG. 2, second C-shaped member 24 fits into a cavity formed by first C-shaped member 22 to form the interlocking C-shapes of the insulation layer 20. As shown in FIGS. 3-8, the insulation layer 20 of the insulated container 10 may be assembled by folding respective C-shaped members 22, 24. As shown in FIG. 3, the C-shaped members 22, 24 may have in unfolded state that is a flat rectangular shape. As shown in FIGS. 4-7, hinges 31, 33 and 41, 43 may be formed by folding. These folds separate the portions 30, 32, 34, 40, 42, 44 of each C-shaped member 22, 24.

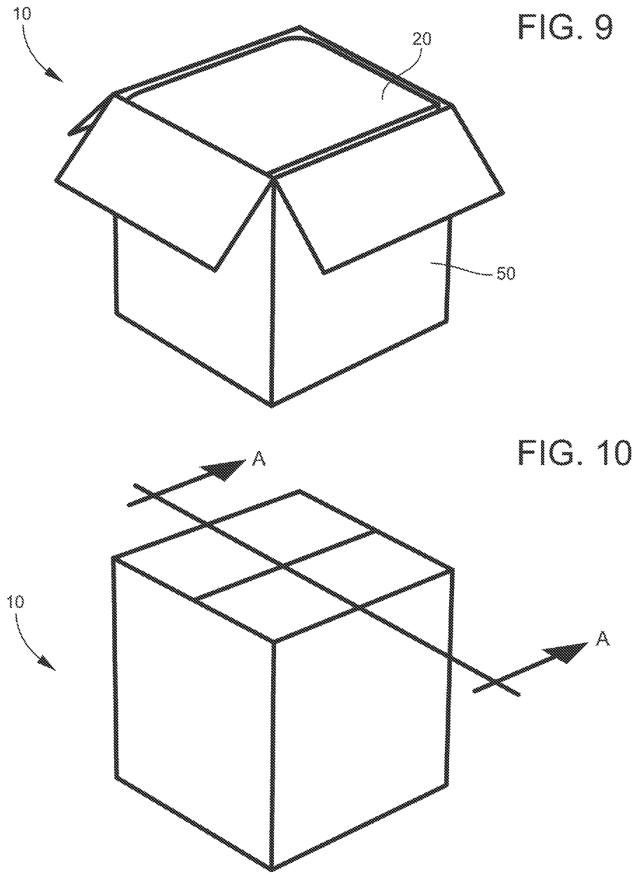

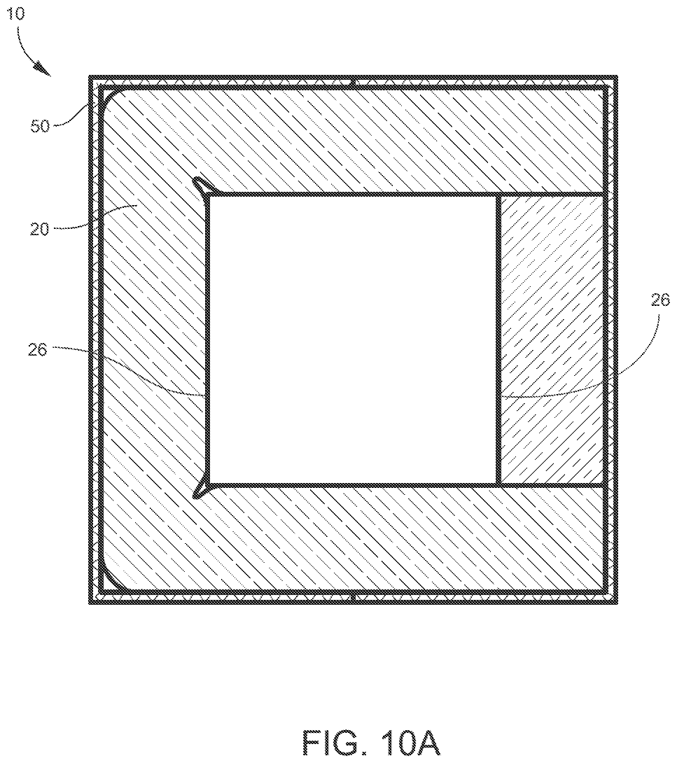

FIG. 9 shows the fully assembled insulated container 10 with the lid of the rigid container 50 open. FIG. 10 visualizes the cross-section A-A which is shown in FIG. 10A. In particular, the cross section A-A shows the insulation layer 20 inside the rigid container 50. The natural fiber lamentation layer 26 is shown on the contact surfaces. Importantly, there is no plastic or non-biodegradable layer between the insulation layer 20 and the rigid container 50 as is present in the prior art of FIG. 2. That is, there is no additional plastic housing surrounding the insulation layer 20. Both to the rigid container 50 and the internal cavity of the insulate container.

FIG. 11 shows the insulated container 10 of FIGS. 1-10A but where the natural fiber insulation layer has not been added during the manufacturing process. Accordingly, the cotton waste of the insulation layer 20 is exposed.

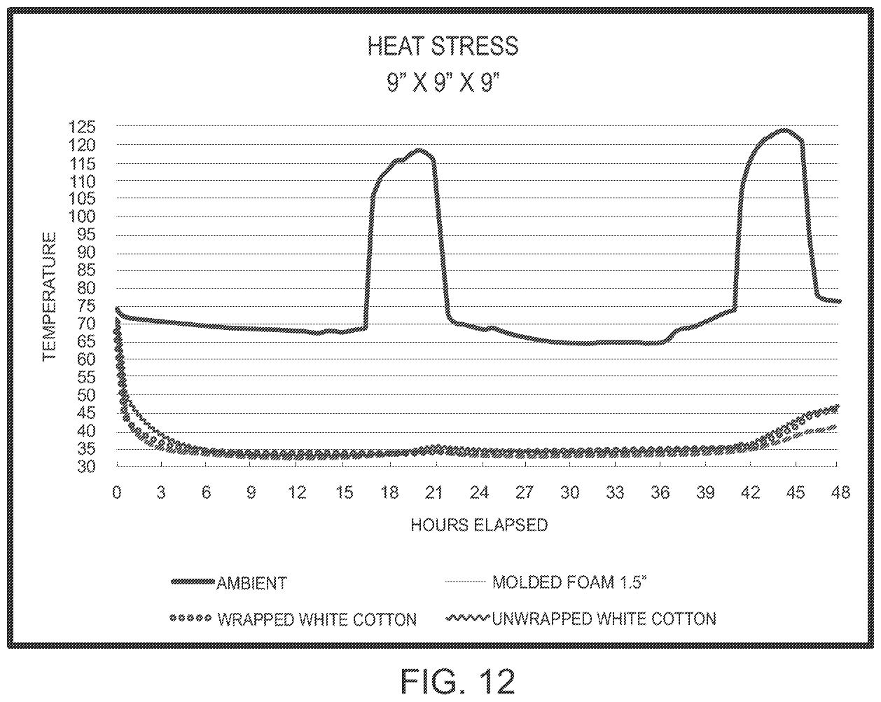

An embodiment of the invention may be created wherein the container is capable of maintaining a constant internal temperature for 48 hours where three 500 ML and two 250 ML IV bags are cooled by four 24 oz frozen ice packs. The ice packs are placed at the top and bottom below the payload. FIG. 12 shows heat stress test results which were recorded by individual data loggers within and outside the test package as well as in proximity to the IV bags. The top line shows the ambient temperature outside the insulated container. The other lines show “wrapped white cotton” “molded 1.5 inch foam” and “unwrapped white cotton.”

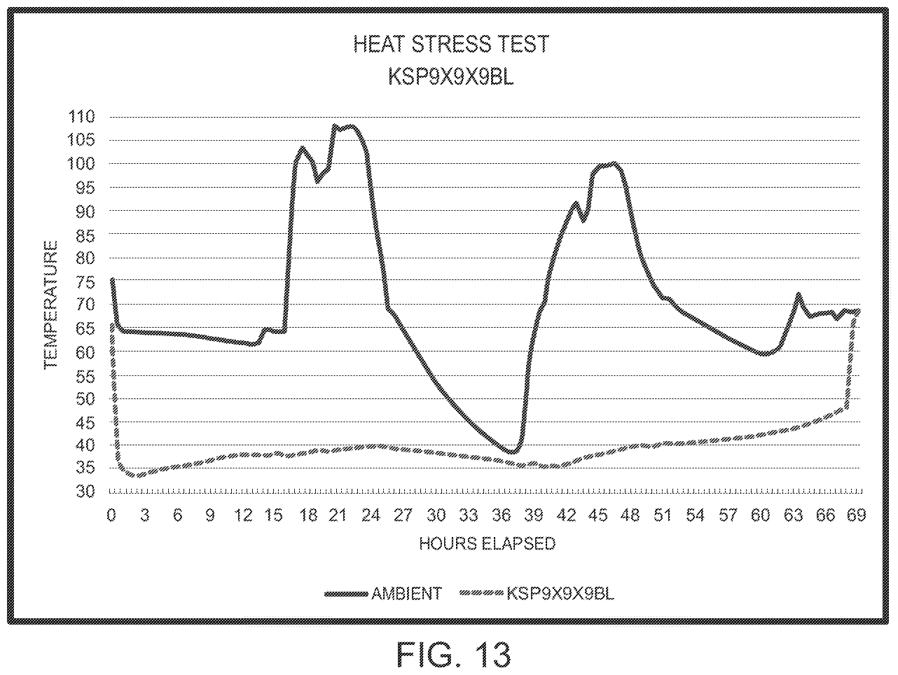

Another embodiment of the invention may be created wherein the container is capable of maintaining a constant internal temperature for 48 hours where six 600 ML IV bags are cooled by four 24 oz frozen ice packs. The ice packs are placed at the top and bottom below the payload. FIG. 13 shows heat stress test results which were recorded by individual data loggers within and outside the test package as well as in proximity to the IV gabs. The top line shows the ambient temperature outside the insulated container. The lower line shows the internal temperature.

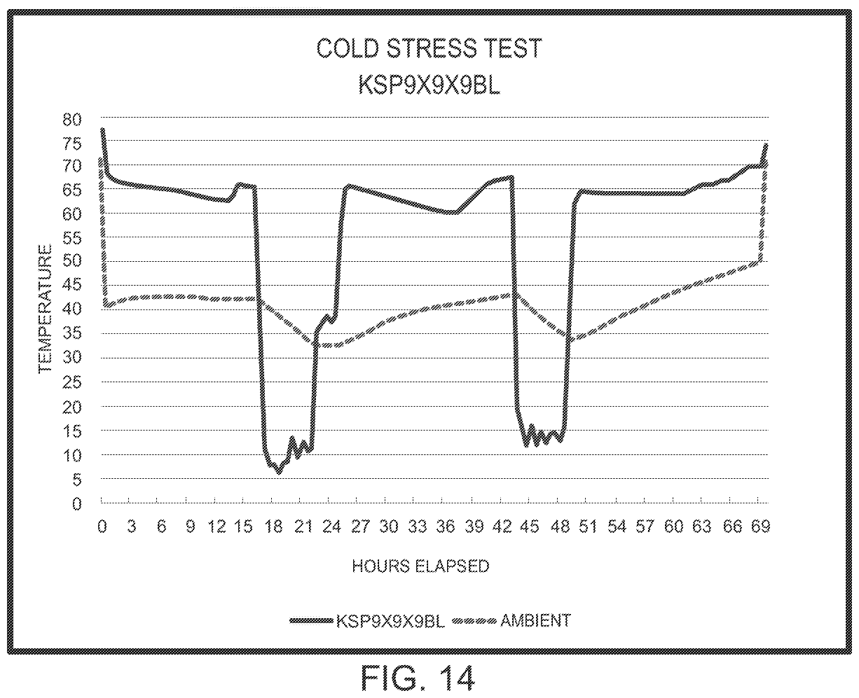

Another embodiment of the invention may be created wherein the container is capable of maintaining a constant internal temperature for 48 hours where six 600 ML IV bags are cooled by two 24 oz frozen ice packs and two 24 oz ambient ice packs. The ice packs are placed at the top and bottom below the payload. FIG. 14 shows cold stress test results which were recorded by individual data loggers within and outside the test package as well as in proximity to the IV gabs. The top line shows the ambient temperature outside the insulated container. The lower line shows the internal temperature.

Another embodiment may be created where the insulated container 10 complies with test scope protocol ISTA 7D such that it maintains temperature above 2° C. and below 8° C., without freezing, in simulated summer/heat stress conditions for a 48 hour distribution cycle. According to the ISTA 7D test, six 24 oz gel ice packs were added to the insulated container 10 with a payload of six 500 mL IV bags (Lactated Ringer's Solution USP), conditioned to 3° C.

Another embodiment may be created where the insulated container 10 complies with test scope protocol ISTA 7D such that it maintains temperature above 2° C. and below 8° C., without freezing, in simulated winter/cold stress conditions for a 48 hour distribution cycle. According to the ISTA 7D test, four 24 oz gel ice packs were added to the insulated container 10 with a payload of ten 500 mL IV bags (Lactated Ringer's Solution USP), condition to 3° C.

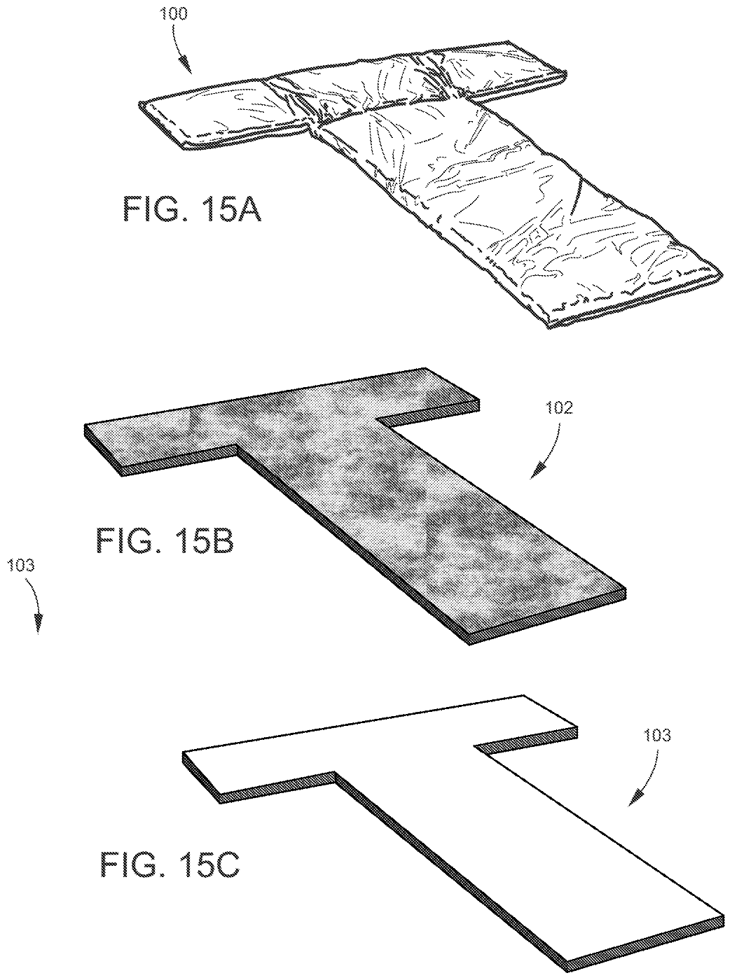

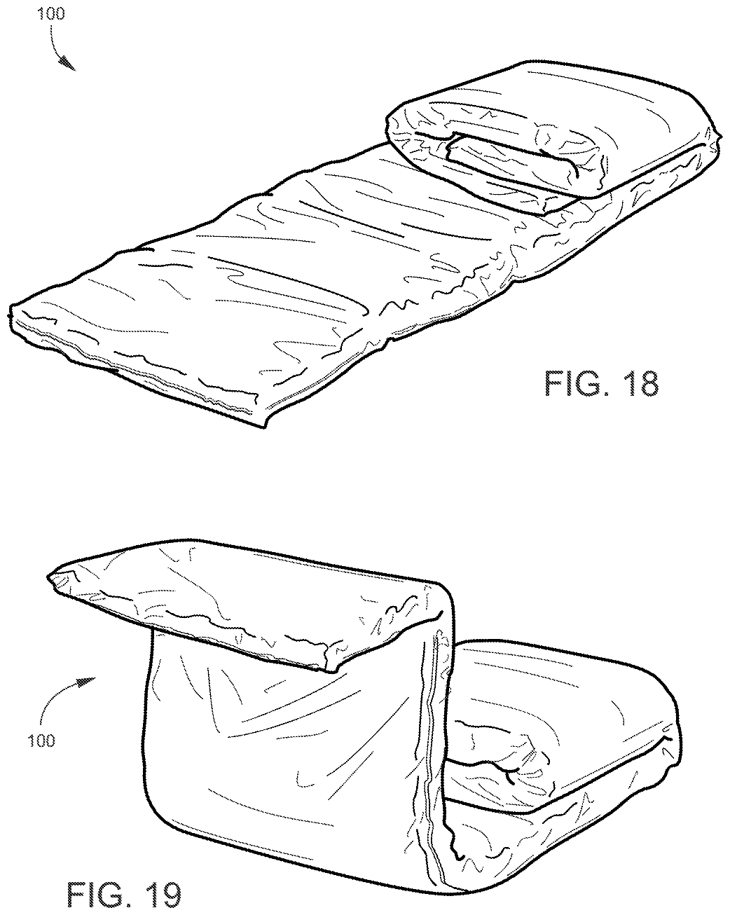

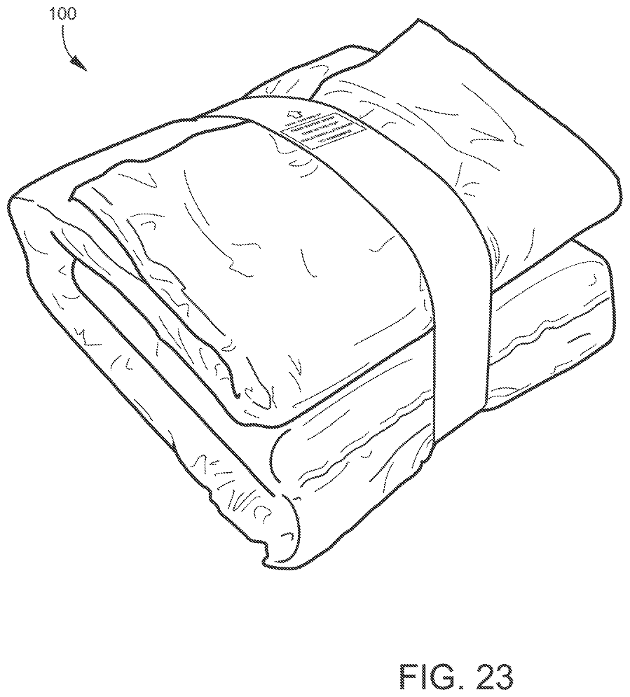

Referring to FIG. 15A through FIG. 28, another embodiment of the invention may include an insulated container 100 which is formed in a capital “T” shape. The T shape may be formed from natural fibers such as cotton. The fibers may be postindustrial, pre-consumer recycled cotton. As shown in FIG. 15A, the fibers may be enclosed in a wrapping. The wrapping may serve to protect contents of the container and may also allow smaller fibers to be used which are contained in the wrapping. The wrapping may be a plastic bag. The plastic bag may be biodegradable.

As shown in FIG. 15B, rather than the wrapping of FIG. 15A, the natural fibers 102 are exposed. Large pads of natural fibers may be created and the T shape cut from the natural fibers. Multiple T shapes may be cut from a single pad. Any waste material from the pads may be further recycled to form additional pads or may be recycled for other purposes.

As shown in FIG. 15C, a natural fiber lamination layer 126 has been applied to the fibers 103. The natural fiber lamination layer 126 may be paper and may have markings or other indicia applied. As with the embodiment of FIG. 15A, pads may be prepared and the T shape may be cut from the pad. Multiple T shapes may be cut from a single pad. Any waste material from the pads may be further recycled to form additional pads or may be recycled for other purposes.

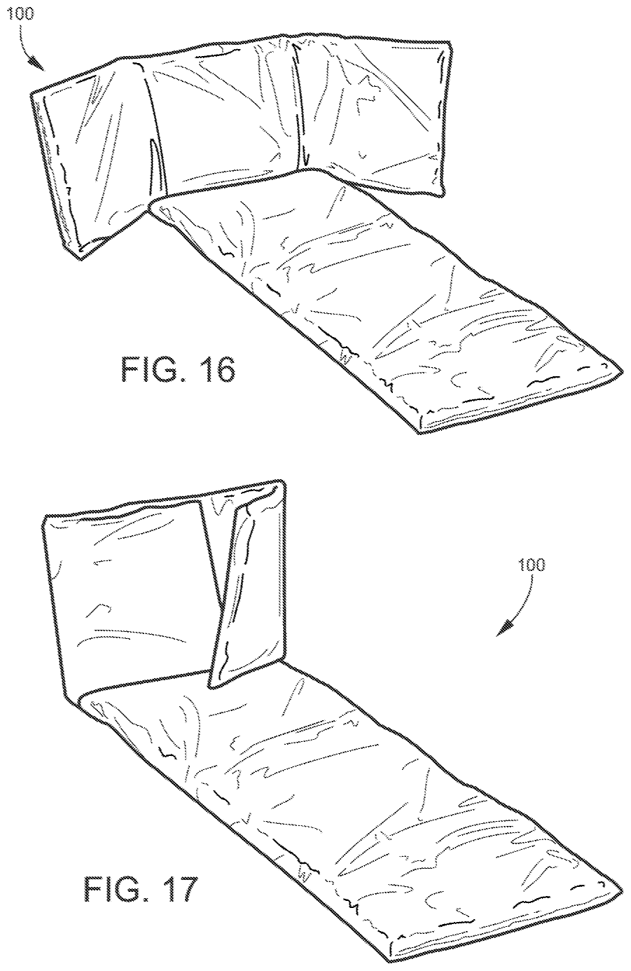

FIGS. 16 through 23 show how the insulated container 100 having the T shape may be folded into a compact form for shipment according to an aspect of the present invention. Though these figures show the T shape embodiment of FIG. 15A, one of skill in the art will understand that the same method of folding may be realized with the embodiments of 15A, 15B, or 15C.

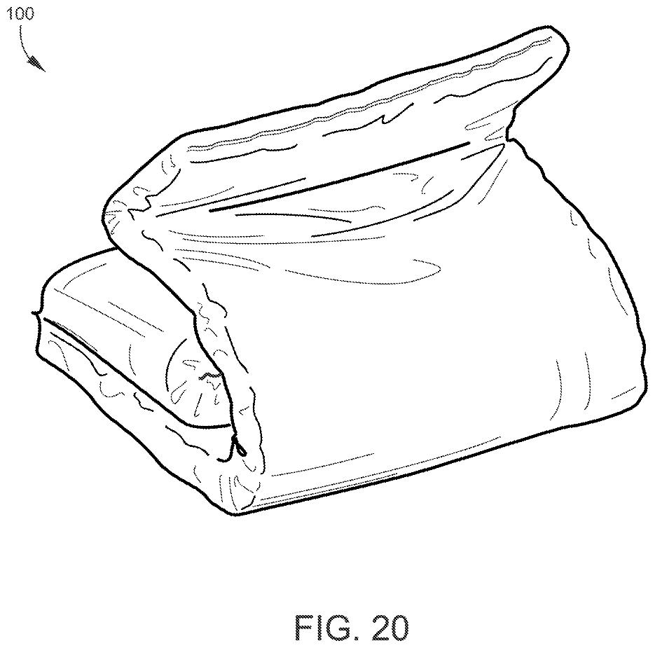

As shown in FIGS. 16-18, the rear panel 110, left panel 112, and right panel 114 are folded up together and down onto bottom panel 116. As shown in FIG. 19, the front panel 118 is folded over up and, in FIG. 20, is folded over the rear panel 110. The top panel 120 (or “lid”) is then folded over the front panel 118.

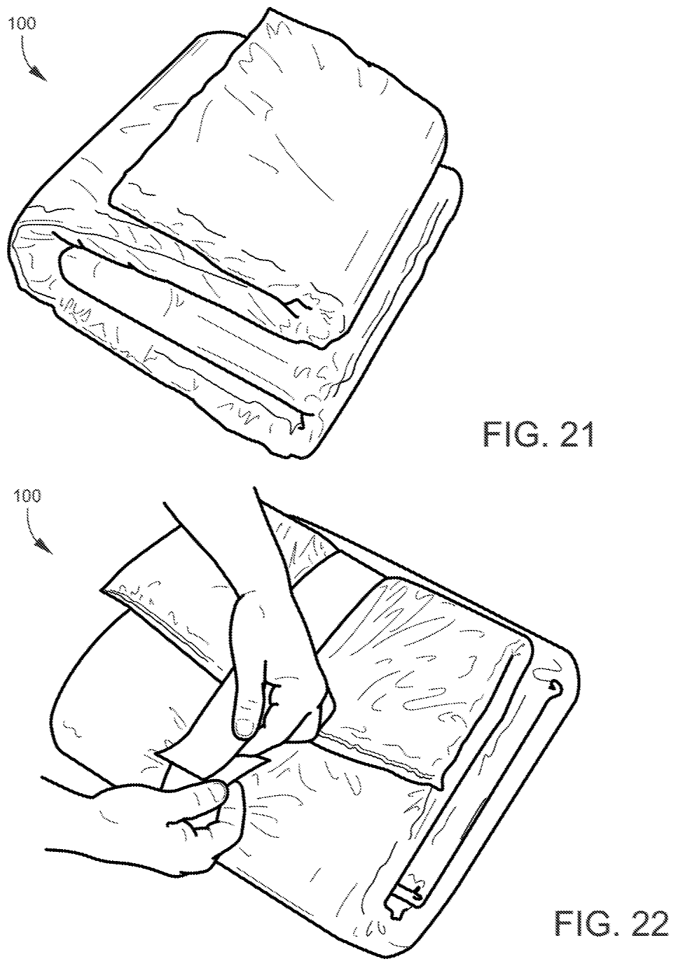

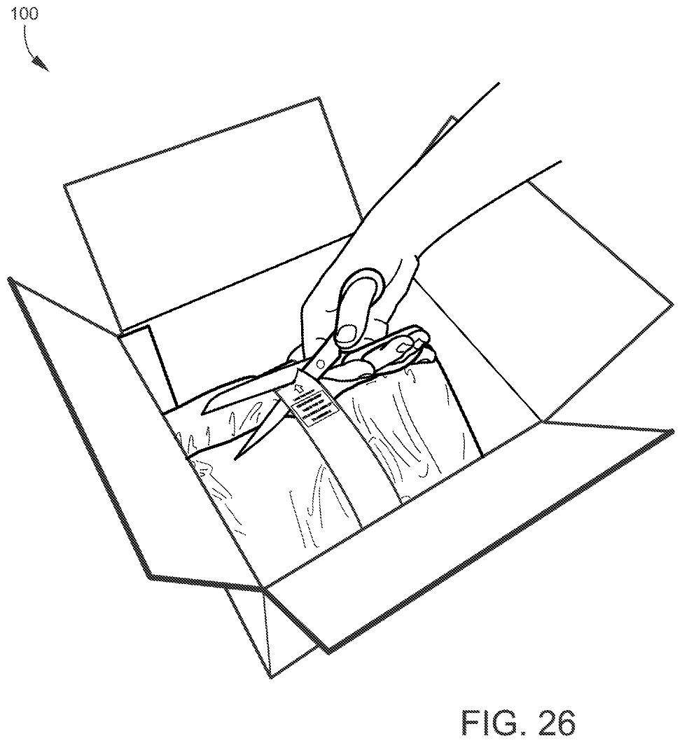

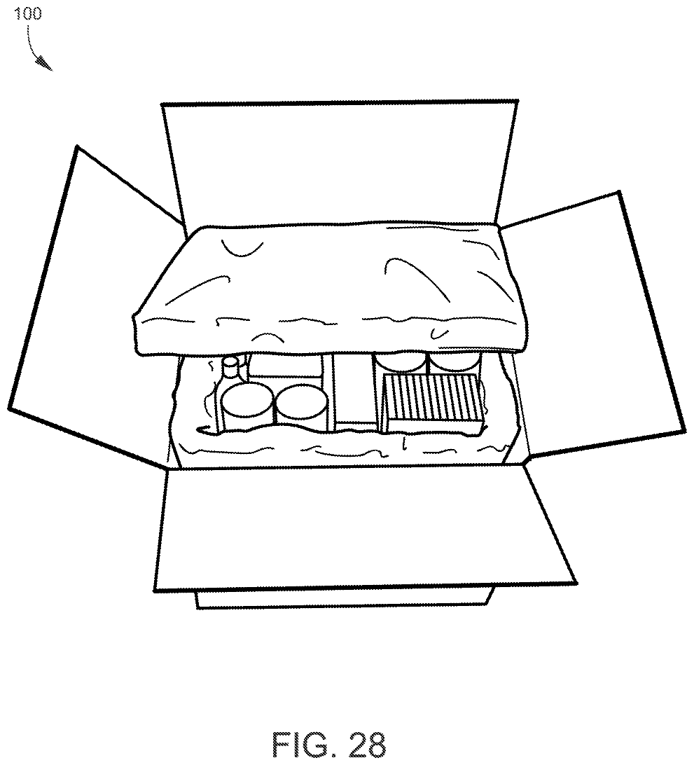

As shown in FIG. 21, a band 122 may be wrapped around the folded container 100 for transport. The band 122 may keep the folded container 100 in a compact folded condition for transport. The band 122 may be made of paper, plastic, natural fibers, or other biodegradable material. Alternatively, the band may be made of a reusable material. The band 122 is designed to be easily connected when the container 100 is folded and is also designed to be easily disconnected as shown in FIG. 26. The band 122 may be connected by way of an adhesive, hook and loop fasteners, snaps, buttons, and the like. The band 122 may also be disconnected and unwrapped from the folded container 100 by tearing, cutting, pulling the band 100. The band 122 may have a perforation which aids in removal. The band 122 may feature a tab and tongue system where a tab is pealed from the band 122 to allow an adhesive to attach the respective ends of the band 122. According to another embodiment, the band 122 may be attached, detached, and reattached at a same or different location along the band such that the attachment point additionally serves the function of a closure of the top 120 of the container 100 in the unfolded state of FIG. 28.

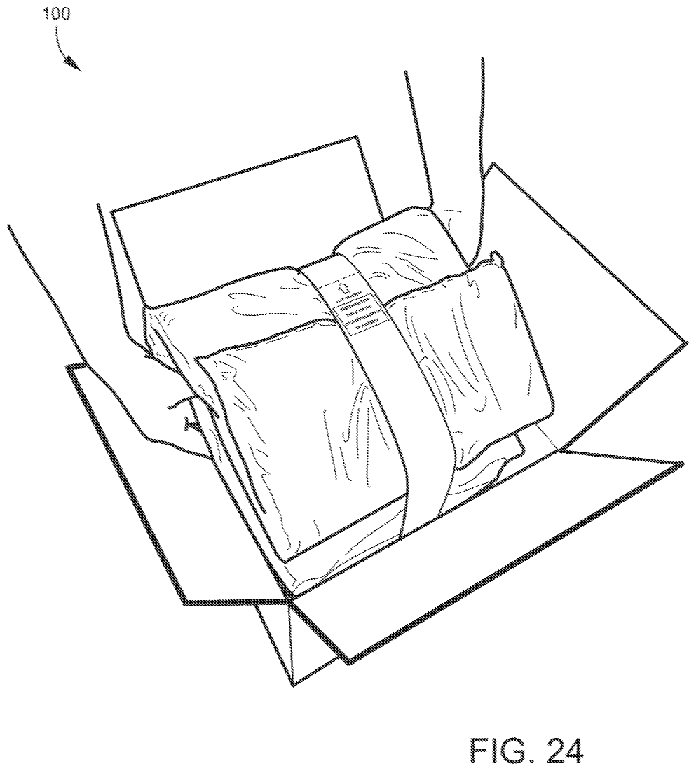

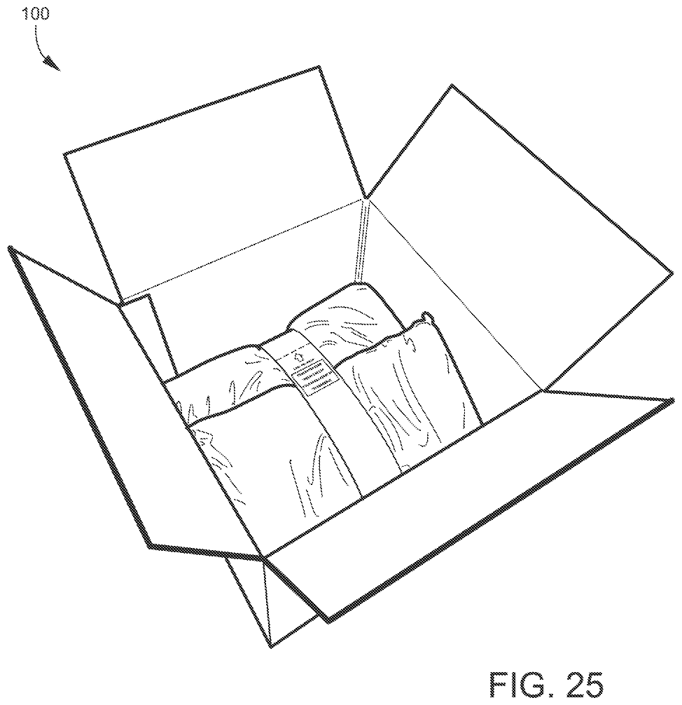

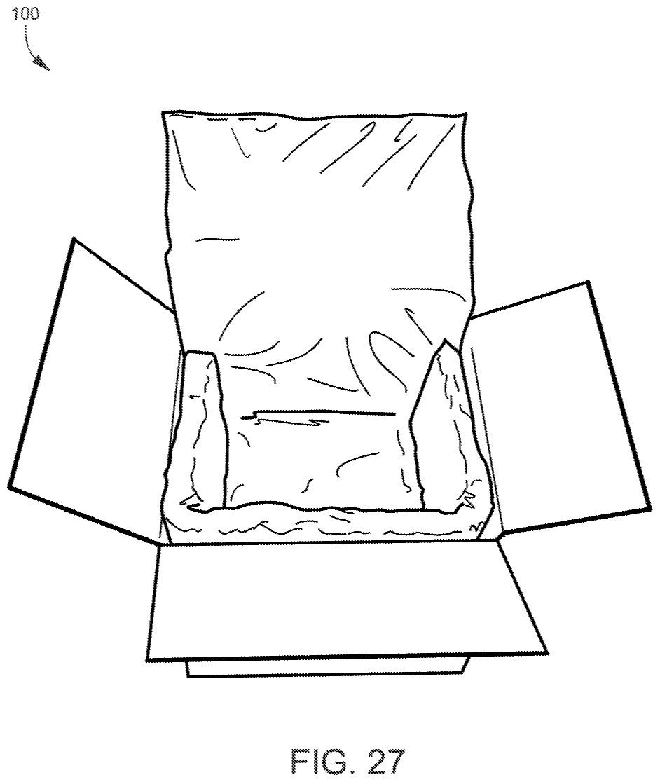

Once the band 122 is in place, the folded container is ready for shipment form the manufacturer to a packager. As shown in FIGS. 24 and 25, once the packager receives the folded container 100, the packager may place the folded container 100 into a rigid container 150. The rigid container 150 may be a box and it may be mad of cardboard. Once the folded container 100 is in the rigid container 150, the packager may remove the band 122 as shown in FIG. 26. The packager may then partially unfold the panels of the container 100 as shown in FIG. 27 to form an inner void which can contain products as shown in FIG. 28.

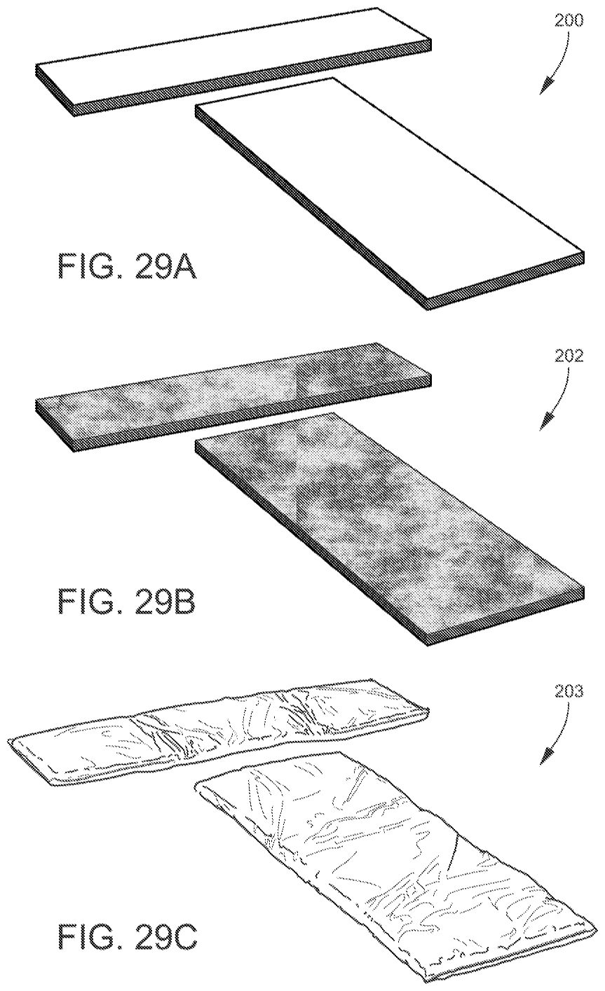

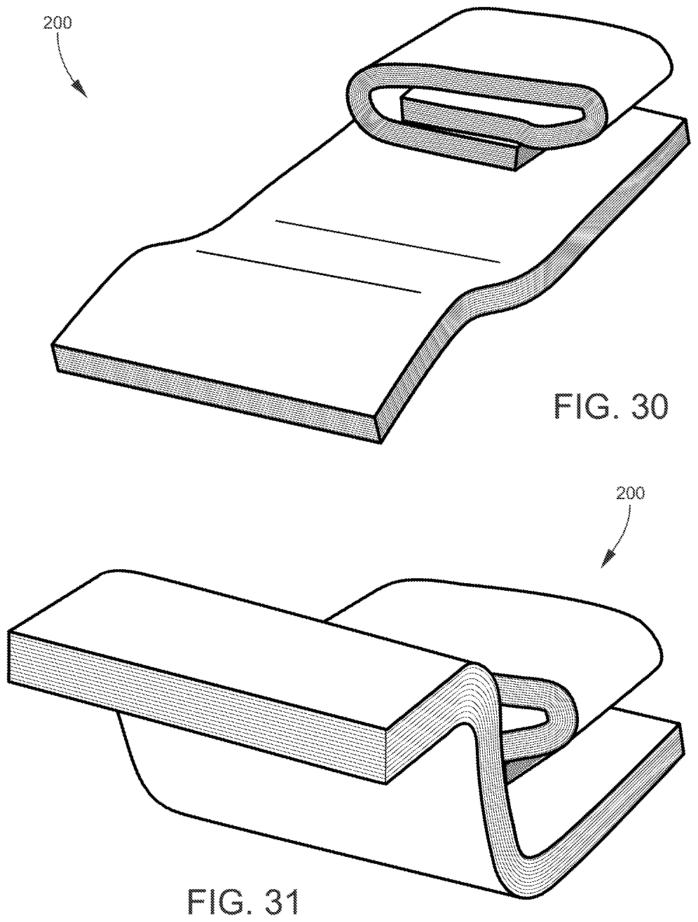

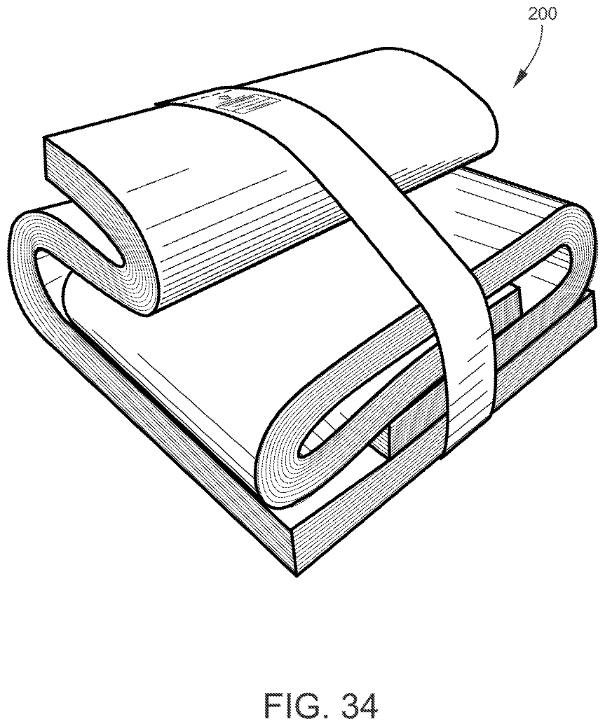

FIGS. 29A, 29B, and 29C show a further embodiment of the insulated container 200 which utilizes a pair of pads. These pads are similar to the pads of FIG. 1 in that they ultimate form an interlocking C shape inside a rigid container. However, the embodiments of FIGS. 30-34 show how the pair of pads may be folded for compact transport.

Additionally, the embodiments of FIGS. 29A, 29B, and 29C may be formed from natural fibers such as cotton. The fibers may be postindustrial, pre-consumer recycled cotton. As shown in FIG. 29A, the fibers may the natural fibers 200 may be covered with a lamination layer 226. As shown, a natural fiber lamination layer 226 has been applied to the fibers 200. The natural fiber lamination layer 226 may be paper and may have markings or other indicia applied. Large pads of natural fibers may be created and the smaller pads cut from the natural fibers. Multiple pads 200 may be cut from a single pad. Any waste material from the pads may be further recycled to form additional pads or may be recycled for other purposes. Any waste material from the pads may be further recycled to form additional pads or may be recycled for other purposes.

As shown in FIG. 29B, according to one embodiment the pads 202 do not have a lamination layer. As show in FIG. 29C, according to another embodiment, the pads 203 may be enclosed in a wrapping. The wrapping may serve to protect contents of the container and may also allow smaller fibers to be used which are contained in the wrapping. The wrapping may be a plastic bag. The plastic bag may be biodegradable.

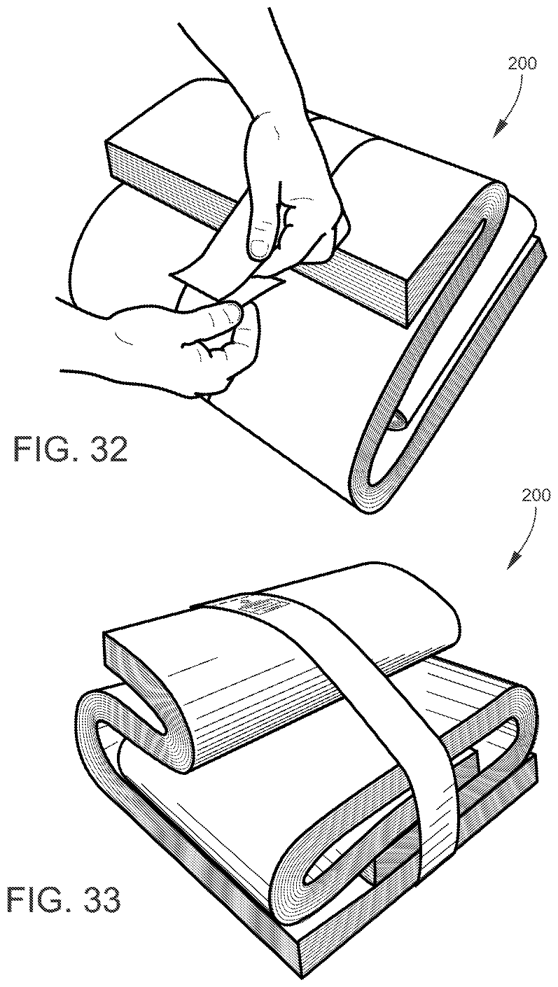

As shown in FIG. 30-34, the pair of pads 200 may be folded for compact transport. As shown in FIG. 30, the rear panel 210, the left panel 212, and the right panel 214 which are part of pad “A” 211 are folded and placed upon the bottom panel 216 of pad “B”. As shown in FIGS. 31 and 32, the front panel 218 of pad “B” is folded up and over the rear panel 210 of pad “A”. The top panel 220 (or “lid”) is then folded over the front panel 218.

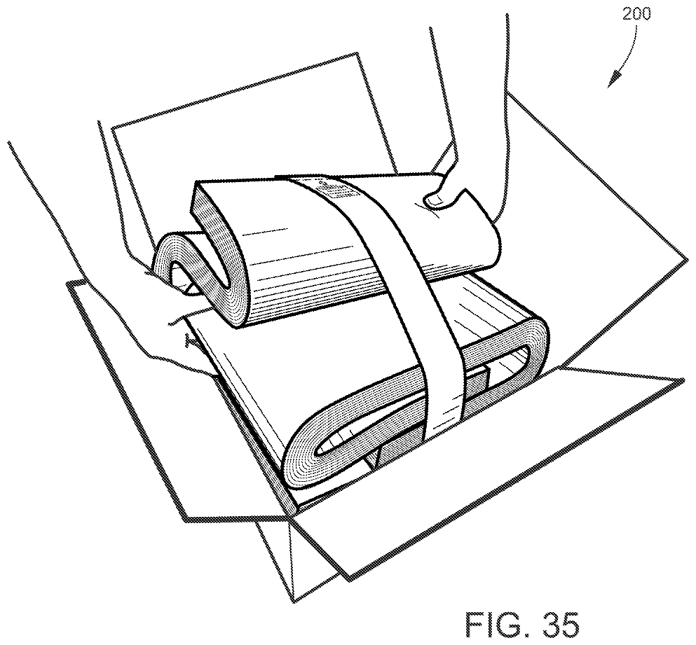

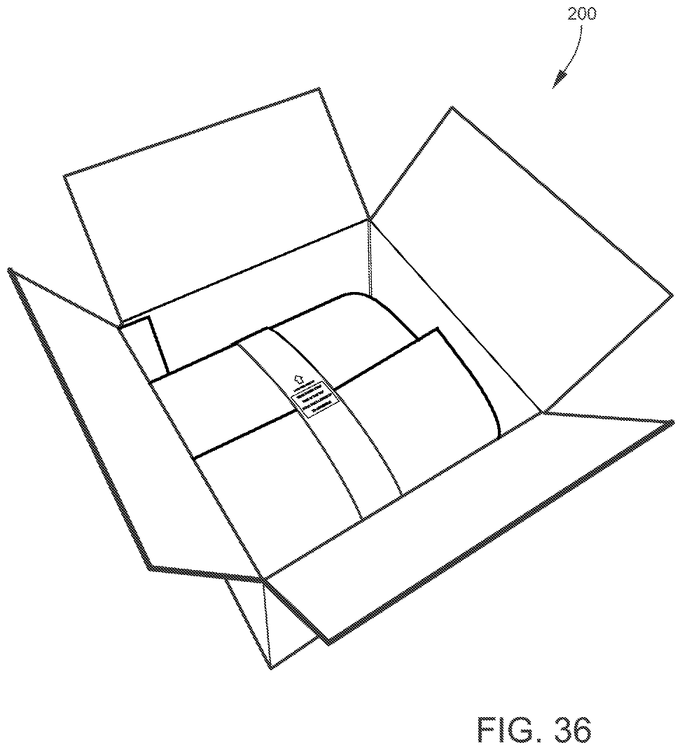

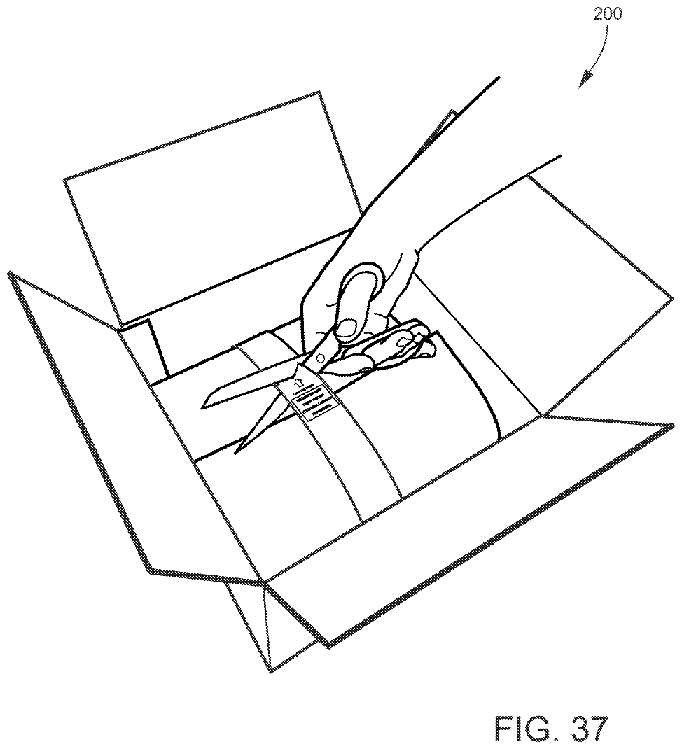

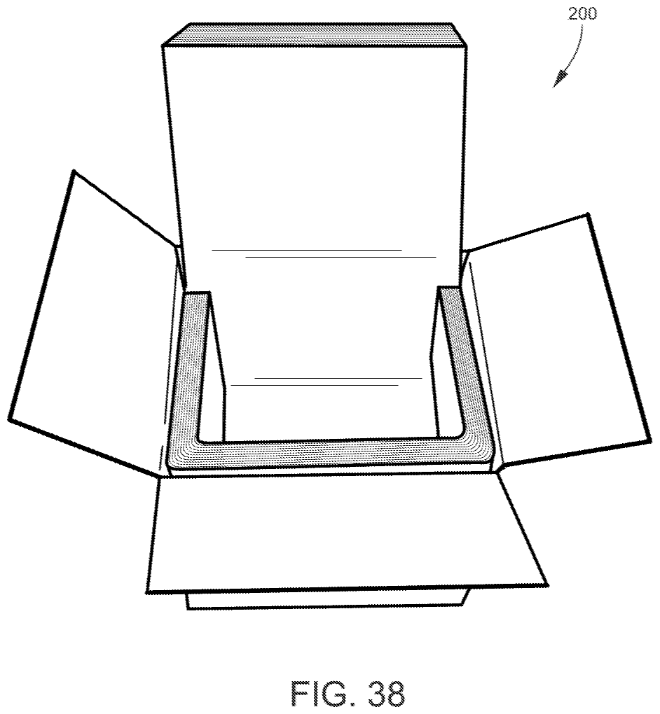

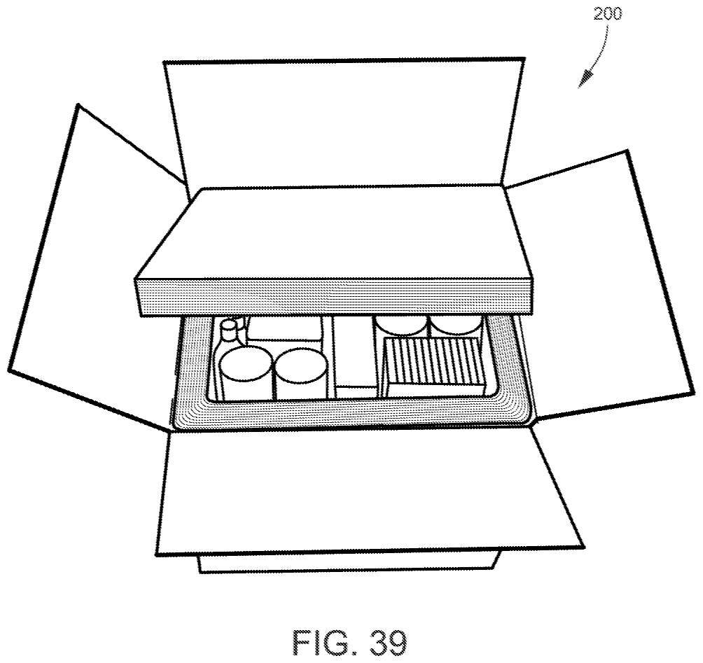

As shown in FIGS. 32 through 34, a band 222 may secure the folded pads 200 in a folded compact form for transportation from a manufacturer to a packager. As shown in FIGS. 35 and 36, the packager may place the folded pads 200 into a rigid container 250. As shown in FIG. 37, the packager may separate or otherwise remove the band 222 so that the insulated pads can be partially unfolded within the rigid container as shown in FIG. 38. As shown in FIG. 39, products may be placed inside the container 200 for shipment.

An insulated container 10, 100, 200 according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims. It is envisioned that other embodiments may perform similar functions and/or achieve similar results. Any and all such equivalent embodiments and examples are within the scope of the present invention and are intended to be covered by the appended claims.

What is claimed is:

1. An insulator configured for installation inside of a cuboid container to insulate the cuboid container, the insulator comprising:
an insulation layer, operable from an unfolded position to an operating position and comprising a “T” shape in the unfolded position; and
wherein, the operating position comprises a plurality of folds to form the insulation layer into a cuboid shape configured to fit within the cuboid container;
wherein the insulation layer comprises a cotton fiber material;
a lamination layer attached to at least one surface of the insulation layer, wherein at least an unwrapped portion of the insulation layer is not covered by the lamination layer,
wherein, in the operating position, the insulation layer comprises six panels configured to line a top, a bottom, and four sides of the cuboid container and to define a compartment for receiving and insulating one or more articles, and
wherein the unwrapped portion is configured to be exposed to an environment within the cuboid container.

2. The insulator of claim 1, wherein the lamination layer is a natural fiber lamination layer.

3. The insulator of claim 1, wherein the cuboid shape formed by the insulation layer in the operating position is a cubic shape, and the six panels are square panels, and the insulator is configured for installation inside the cuboid container in a cubic configuration where the top, the bottom, and the four sides of the cuboid container are squares.

4. The insulator of claim 1, wherein the lamination layer is a single layer, such that the lamination layer has a first surface facing the cotton fiber material and a second surface facing away from the cotton fiber material.

5. The insulator of claim 1, wherein the cotton fiber material is formed from a post-industrial, pre-consumer cotton waste.

6. The insulator of claim 5, wherein the post-industrial, pre-consumer cotton waste comprises fiber material gleaned or trimmed as part of a cotton manufacturing and converting process.

7. The insulator of claim 1, wherein the insulation layer has an inner surface configured to face inwardly into the compartment in the operating position, an outer surface opposite the inner surface, and a plurality of edge surfaces extending between the inner surface and the outer surface, and wherein the lamination layer is attached to at least a contact surface of the inner surface of the insulation layer.

8. The insulator of claim 7, wherein the lamination layer is further attached to the outer surface of the insulation layer.

9. The insulator of claim 7, wherein the contact surface is configured for confronting the one or more articles when the insulation layer is in the operating position.

10. The insulator of claim 7, wherein the unwrapped portion includes the plurality of edge surfaces.

11. A method of preparing an insulated container comprising:
providing an insulation layer comprising a cotton fiber material and formed in a “T” shape in an unfolded, flat position, wherein at least an unwrapped portion of the insulation layer is unwrapped, the insulation layer further having a lamination layer attached to at least one surface of the insulation layer, wherein at least an unwrapped portion of the insulation layer is not covered by the lamination layer; and
folding the insulation layer into an operating position and placing the insulation layer into the insulated container, such that the insulation layer comprises six panels lining a top, a bottom, and four sides of the insulated container and defining a compartment for receiving and insulating one or more articles,
wherein at least a portion of an outermost surface of the unwrapped portion is configured to be exposed to an environment within the insulated container.

12. The method of claim 11, wherein the insulation layer in the operating position has a cuboid shape, and the insulated container has a cuboid configuration.

13. The method of claim 12, wherein the insulation layer in the operating position has a cubic shape, and the six panels are square panels, and the cuboid container has a cubic configuration where the top, the bottom, and the four sides of the cuboid container are squares.

14. The method of claim 11, wherein the lamination layer is a natural fiber lamination layer.

15. The method of claim 11, wherein the lamination layer is a single layer, such that the lamination layer has a first surface facing the cotton fiber material and a second surface facing away from the cotton fiber material.

16. The method of claim 11, wherein the cotton fiber material is formed from a post-industrial, pre-consumer cotton waste gleaned or trimmed as part of a cotton manufacturing and converting process.

17. The method of claim 11, wherein the insulation layer has an inner surface facing inwardly into the compartment in the operating position, an outer surface opposite the inner surface, and a plurality of edge surfaces extending between the inner surface and the outer surface, and wherein the lamination layer is attached to at least a contact surface of the inner surface of the insulation layer, and the unwrapped portion includes the plurality of edge surfaces.

18. The method of claim 17, wherein the contact surface is configured for confronting the one or more articles when the insulation layer is in the operating position.

19. An insulator configured for installation inside of a container to insulate the container, the insulator comprising:
an insulation layer, operable from an unfolded position to an operating position and comprising a “T” shape in the unfolded position, the insulation layer having an inner surface configured to face inwardly into the container in the operating position, an outer surface opposite the inner surface, and a plurality of edge surfaces extending between the inner surface and the outer surface;
wherein, the operating position comprises a plurality of folds to form the insulation layer into a shape configured to fit within the container,
wherein the insulation layer comprises a cotton fiber material; and
a lamination layer attached to at least one of the inner surface of the insulation layer and the outer surface of the insulation layer to form a wrapped portion of the insulation layer, wherein the insulation layer further has an unwrapped portion configured to be exposed to an environment within the container, and the unwrapped portion includes the plurality of edge surfaces.

20. The insulator of claim 19, wherein the lamination layer is a natural fiber lamination layer.

21. The insulator of claim 19, wherein the lamination layer is a single layer, such that the lamination layer has a first surface facing the cotton fiber material and a second surface facing away from the cotton fiber material.

22. The insulator of claim 19, wherein the cotton fiber material is formed from a post-industrial, pre-consumer cotton waste gleaned or trimmed as part of a cotton manufacturing and converting process.

23. An insulator configured for installation inside of a container to insulate the container, the insulator comprising:
an insulation layer comprising a cotton fiber material, operable from an unfolded position to an operating position and comprising a “T” shape in the unfolded position, the insulation layer having an inner surface configured to face inwardly into the container in the operating position, an outer surface opposite the inner surface, and a plurality of edge surfaces extending between the inner surface and the outer surface,
wherein the operating position comprises a plurality of folds to form the insulation layer into a shape configured to fit within the container; and
a lamination layer applied to at least at least a contact surface of the inner surface of the insulation layer, but not to any of the edge surfaces of the insulation layer.

24. The insulator of claim 23, wherein the lamination layer is a natural fiber lamination layer.

25. The insulator of claim 23, wherein the lamination layer is a single layer, such that the lamination layer has a first surface facing the cotton fiber material and a second surface facing away from the cotton fiber material.

26. The insulator of claim 23, wherein the cotton fiber material is formed from a post-industrial, pre-consumer cotton waste gleaned or trimmed as part of a cotton manufacturing and converting process.
